(19) United States
(12) Patent Application Publication
(10) Pub. No.: US 2016/0196423 A1
(43) Pub. Date: Jul. 7, 2016

(54) SMART DEVICE AND METHOD FOR DYNAMICALLY DETECTING APPLICATIONS

(71) Applicant: Rangecloud Information Technology Co., Ltd., New Taipei City (TW)

(72) Inventors: I-TE TSAI, New Taipei City (TW); Ming Hsien Wang, New Taipei City (TW)

(21) Appl. No.: 14/967,949

(22) Filed: Dec. 14, 2015

(30) Foreign Application Priority Data
Jan. 5, 2015 (TW) 104100040

(51) Int. Cl. G06F 21/52; G06F 21/55

(52) U.S. Cl. CPC G06F 21/52; G06F 21/55

(57) ABSTRACT

A method for dynamically detecting applications is provided, the method including the following steps: opening a smart device, and executing a testing program to enter a program of detecting applications, wherein the testing program is installed to a bottom layer of the operating system; in the program of detecting applications, executing all functions of an application under test; recording execution results of the all functions of the application under test; analyzing, from the execution results recorded, which functions the application under test executes, where and how many times which data is transmitted and execution data of which text files and folders is established; and displaying which functions the application under test executes, where and how many times which data is transmitted and execution data of which text files and folders is established. The present invention further includes a smart device and a computer program product implementing the method.

### BACKGROUND

1. Technical Field

The present invention relates to the technical field of smart devices, and in particular, to a smart device and method for dynamically detecting applications, and a computer program product.

2. Related Art

Smartphones have been one of the smart devices commonly used by people, and in order to meet people's various demands for using the smartphones, lots of applications (apps) are developed to make the smartphones have more functions. However, some applications malicious or neglected by development will do harm to use of the smartphones or steal data inside the smartphones, resulting in that users are worried about use of the smartphones or personal data is stolen.

In order to prevent that the applications malicious or neglected by development will do harm to use of the smartphones or steal data inside the smartphones, systems or tools for detecting applications are put forward to perform detection. Currently, systems or tools for detecting applications on the market need to use source codes of the applications for detection, a test cannot be carried out if the source codes of the applications are not provided, or the applications may be malicious or neglected although the source codes are provided, and there may be errors between execute files of the applications complied and the original source codes, resulting in that there are errors in detection results; moreover, the manner of manually detecting source codes of the applications requires lots of detection time and manpower for detection, and thus the implementation rate of the detection is not good.

### SUMMARY

In view of the foregoing problems, an objective of the present invention is to provide a smart device and method for dynamically detecting applications, and a computer program product, which, without providing source codes of the applications, can detect the applications, to detect applications malicious or neglected by development that will do harm to use of smart devices or steal data inside the smart devices, and detecting the applications by the smart device can save detection time and manpower, thus increasing the implementation rate of the detection.

A first aspect of the present invention provides a method for dynamically detecting applications, the method being implemented by a smart device, and the method including the following steps:

opening the smart device, and executing, by a microprocessor, an operating system and a testing program to enter a program of detecting applications, wherein the testing program is installed to a bottom layer of the operating system;

in the program of detecting applications, executing, by the microprocessor, all functions of an application under test;

recording execution results of the all functions of the application under test in a memory of the smart device;

analyzing, by the microprocessor, from the execution results recorded in the memory, which functions the application under test executes, where and how many times which data is transmitted and execution data of which text files and folders is established; and

displaying, by a screen of the smart device, which functions the application under test executes, where and how many times which data is transmitted and execution data of which text files and folders is established analyzed by the microprocessor.

A second aspect of the present invention provides a smart device for dynamically detecting applications, including:

a memory;

a microprocessor, executing an operating system and a testing program, to enter a program of detecting applications, executing all functions of an application under test, recording execution results of the all functions of the application under test in the memory, and analyzing, from the recorded execution results, which functions the application under test executes, where and how many times which data is transmitted and execution data of which text files and folders is established, wherein the testing program is installed to a bottom layer of the operating system; and

a screen, displaying which functions the application under test executes, where and how many times which data is transmitted and execution data of which text files and folders is established analyzed by the microprocessor.

A third aspect of the present invention provides a computer program product with a program stored therein, wherein the method according to the first aspect of the present invention can be completed after a smart device is loaded with the program and executes the program.

The smart device and method for dynamically detecting applications of the present invention will be described below in detail with reference to the following embodiments, and also as set forth in applicants' Taiwanese priority application no. 104100040, filed on Jan. 5, 2015, the entire contents of which are hereby incorporated herein by reference. However, these embodiments are used mainly to assist in understanding the present invention, but not to restrict the scope of the present invention. Various possible modifications and alterations could be conceived of by one skilled in the art to the form and the content of any particular embodiment, without departing from the spirit and scope of the present invention, which is intended to be defined by the appended claims.

### BRIEF DESCRIPTION OF THE DRAWINGS

FIG. 1 is a block diagram of a smartphone for dynamically detecting applications according to the present invention; and

FIG. 2 is a flowchart of a method for dynamically detecting applications according to the present invention.

### DETAILED DESCRIPTION

In order to enable those of ordinary skill in the art to further understand the present invention, preferred embodiments of the present invention are listed below to describe constitution contents and effects to be achieved of the present invention in detail in conjunction with the accompanying drawings.

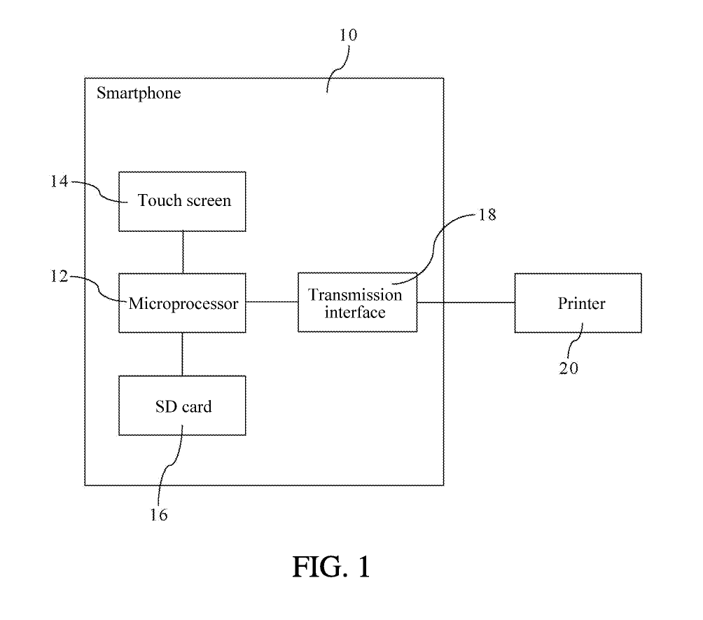

FIG. 1 is a block diagram of a smartphone for dynamically detecting applications according to the present invention. A smartphone 10 which is one of the smart devices includes a microprocessor 12, a touch screen 14, a secure digital (SD) card 16 which is one of the memories and a transmission interface 18.

An operating system, for example, Android or iOS, is stored in the SD card 16 of the smartphone 10 used for detection, and a bottom layer thereof is installed with a testing program used to detect an application. When the smartphone 10 is booted, the microprocessor 12 executes the operating system including the testing program, to enter a program of detecting applications.

The microprocessor 12 executes, for example, all functions of an application under test of an APK file or IPA file, to record execution results of the all functions of the application under test in the SD card 16 in a file form. The microprocessor 12 analyzes the execution results recorded in the SD card 16, to analyze which functions the application under test executes, where (for example, which uniform resource locator (URL) internal data of the smartphone 10 is transmitted to) and how many times which data is transmitted and execution data of which text files and folders is established.

When the microprocessor 12 executes the application under test to transmit the internal data of the smartphone 10 to an external device of URL, the internal data of the smartphone 10 is transmitted to the external device of URL via the transmission interface in a wireless manner.

The screen 14 displays which functions the application under test executes, where and how many times which data is transmitted and execution data of which text files and folders is established analyzed by the microprocessor 12, to allow an inspector to see detection results, and according to where and how many times which data is transmitted, whether the application under test will do harm to use of the smartphone 10 or steal the internal data of the smartphone 10 is judged.

To print out which functions the application under test executes, where and how many times which data is transmitted and execution data of which text files and folders is established, the microprocessor 12 transmits which functions the application under test executes, where and how many times which data is transmitted and execution data of which text files and folders is established to an external device of a printer 20 via the transmission interface 18 in a wireless manner, so as to print out data thereof to allow an inspector to see the detection results.

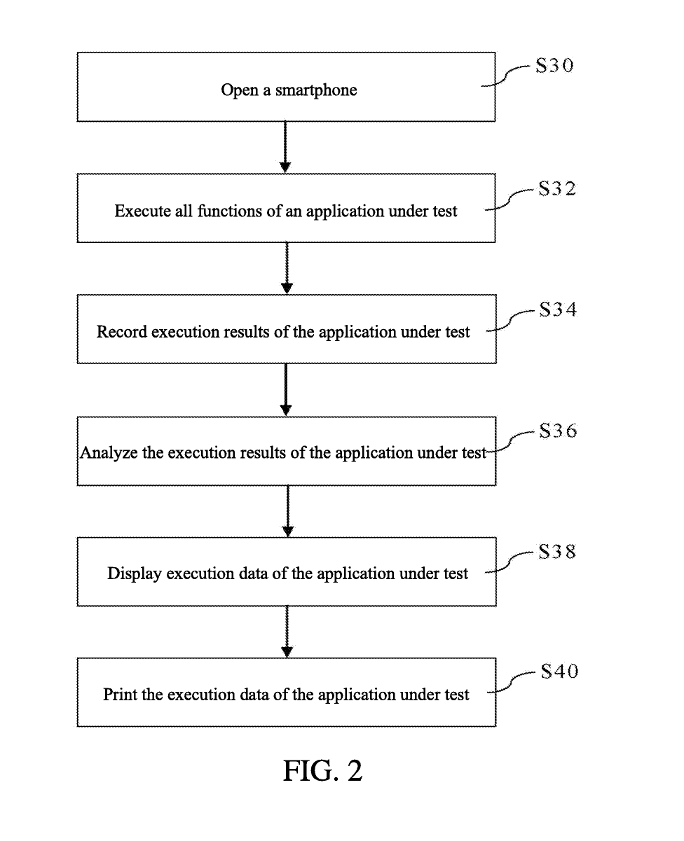

FIG. 2 is a flowchart of a method for dynamically detecting applications according to the present invention. Reference is made to the components of FIG. 1 when process steps of FIG. 2 are described.

In FIG. 2, An operating system, for example, Android or iOS, is stored in the SD card 16 of the smartphone 10 used for detection, and a bottom layer thereof is installed with a testing program used to detect an application. When the smartphone 10 is booted, the microprocessor 12 executes the operating system including the testing program, to enter a program of detecting applications (step S30).

The microprocessor 12 executes, for example, all functions of an application under test of an APK file or IPA file (step S32), to record execution results of the all functions of the application under test in the SD card 16 in a file form (step S34).

The microprocessor 12 analyzes the execution results recorded in the SD card 16, to analyze which functions the application under test executes, where (for example, which URL internal data of the smartphone 10 is transmitted to) and how many times which data is transmitted and execution data of which text files and folders is established (step S36).

For example,

[date, time] xxx.apk

date/date/abc.mkdir

The above indicates that the application xxx.apk establishes a folder /abc.mkdir.

For example,

[date, time] xxx.apk

array[“xxx”, “xxx”] http://URL

The above indicates that the array string data “xxx” is transmitted to a certain URL.

When the microprocessor 12 executes the application under test to transmit the internal data of the smartphone 10 to an external device of URL, the internal data of the smartphone 10 is transmitted to the external device of URL via the transmission interface in a wireless manner.

The screen 14 displays which functions the application under test executes, where and how many times which data is transmitted and execution data of which text files and folders is established analyzed by the microprocessor 12, to allow an inspector to see detection results, and according to where and how many times which data is transmitted, whether the application under test will do harm to use of the smartphone 10 or steal the internal data of the smartphone 10 is judged (step S38).

To print out which functions the application under test executes, where and how many times which data is transmitted and execution data of which text files and folders is established, the microprocessor 12 transmits which functions the application under test executes, where and how many times which data is transmitted and execution data of which text files and folders is established to an external device of a printer 20 via the transmission interface 18 in a wireless manner, so as to print out data thereof to allow an inspector to see the detection results (step S40).

The smartphone 10 detects an application, and the smartphone 10, according to execution data of an application under test analyzed, judges whether the application under test will do harm to use of the smartphone 10 or steal the internal data of the smartphone 10, artificial judgment is unnecessary, and in this way, time and manpower for detecting applications can be saved, so as to increase the implementation rate of the detection.

The method of the present invention can be completed by a computer program product with a program stored therein, and after the smartphone downloads and executes the program, for example, from a network, the steps of the method as described above and shown in the figure can be completed.

The present invention provides a smart device and method for dynamically detecting applications, and a computer program product, and its advantages are as follows: the applications can be detected without provision of source codes of the applications, to detect applications malicious or neglected by development that will do harm to use of smart devices or steal data inside the smart devices, and detecting the applications by the smart device can save detection time and manpower, thus increasing the implementation rate of the detection.

### DESCRIPTION OF REFERENCE SIGNS

10 smartphone

12 microprocessor

14 touch screen

16 SD card

18 transmission interface

20 printer

What is claimed is:

1. A method for dynamically detecting applications, the method being implemented by a smart device, and the method comprising the following steps:
opening the smart device, and executing, by a microprocessor, an operating system and a testing program to enter a program of detecting applications, wherein the testing program is installed to a bottom layer of the operating system;
in the program of detecting applications, executing, by the microprocessor, all functions of an application under test;
recording execution results of the all functions of the application under test in a memory of the smart device;
analyzing, by the microprocessor, from the execution results recorded in the memory, which functions the application under test executes, where and how many times which data is transmitted and execution data of which text files and folders is established; and
displaying, by a screen of the smart device, which functions the application under test executes, where and how many times which data is transmitted and execution data of which text files and folders is established analyzed by the microprocessor.

2. The method according to claim 1, wherein the smart device is a smartphone, the operating system is an Android or an iOS, the application under test is an APK file or an IPA file, and the memory is an SD card.

3. The method according to claim 1, wherein, after the step of displaying, by a screen, which functions the application under test executes, where and how many times which data is transmitted and execution data of which text files and folders is established, the method further comprises the following steps:
outputting, by a transmission interface of the smart device, which functions the application under test executes, where and how many times which data is transmitted and execution data of which text files and folders is established to an external device.

4. The method according to claim 3, wherein, when the microprocessor executes the application under test to transmit internal data of the smart device to the external device, the internal data of the smart device is transmitted to the external device via the transmission interface.

5. A smart device for dynamically detecting applications, comprising:
a memory;
a microprocessor, executing an operating system and a testing program, to enter a program of detecting applications, executing all functions of an application under test, recording execution results of the all functions of the application under test in the memory, and analyzing, from the recorded execution results, which functions the application under test executes, where and how many times which data is transmitted and execution data of which text files and folders is established, wherein the testing program is installed to a bottom layer of the operating system; and
a screen, displaying which functions the application under test executes, where and how many times which data is transmitted and execution data of which text files and folders is established analyzed by the microprocessor.

6. The smart device according to claim 5, wherein the smart device is a smartphone, the operating system is an Android or an iOS, the application under test is an APK file or an IPA file, and the memory is an SD card.

7. The smart device according to claim 5, further comprising:
a transmission interface, outputting which functions the application under test executes, where and how many times which data is transmitted and execution data of which text files and folders is established to an external device.

8. The smart device according to claim 8, wherein, when the microprocessor executes the application under test to transmit internal data of the smart device to the external device, the internal data of the smart device is transmitted to the external device via the transmission interface.
